(19) United States
(12) Patent Application Publication
(10) Pub. No.: US 2025/0119938 A1
(43) Pub. Date: Apr. 10, 2025

(54) NEGOTIATION FOR COORDINATED MEDIUM ACCESS BETWEEN WIRELESS DEVICES

(71) Applicant: QUALCOMM Incorporated, San Diego, CA (US)

(72) Inventors: Sai Yiu Duncan HO, San Diego, CA (US); Abhishek Pramod PATIL, San Diego, CA (US); George CHERIAN, San Diego, CA (US); Alfred ASTERJADHI, San Diego, CA (US); Gaurang NAIK, San Diego, CA (US)

(21) Appl. No.: 18/422,490

(22) Filed: Jan. 25, 2024

Related U.S. Application Data
(60) Provisional application No. 63/588,972, filed on Oct. 9, 2023.

(51) Int. Cl. H04W 74/04; H04W 74/00; H04W 74/0808

(52) U.S. Cl. CPC H04W 74/04; H04W 74/002; H04W 74/0808

(57) ABSTRACT

This disclosure provides methods, components, devices and systems for negotiation for coordinated medium access between wireless devices. Some aspects more specifically relate to techniques for negotiation between wireless devices for medium access. In some examples, wireless devices may transmit requests and responses to negotiate for conflicting medium access periods between wireless devices, where the wireless devices may be in different basic service sets (BSSs). For example, wireless devices such as wireless access points (APs) may broadcast a reservation of medium access periods. In some examples, a first wireless device may transmit a request to negotiate medium access periods with a second wireless device, and the second wireless device may transmit a response to the request. For example, the request to negotiate may request that the wireless devices mutually honor or respect (for example, comply with) one or more of the medium access period reservations of each wireless device.

### CROSS REFERENCE

The present Application for Patent claims the benefit of U.S. Provisional Patent Application No. 63/588,972 by HO et al., entitled “NEGOTIATION FOR COORDINATED MEDIUM ACCESS BETWEEN WIRELESS DEVICES,” filed Oct. 9, 2023, assigned to the assignee hereof, and expressly incorporated by reference herein.

### TECHNICAL FIELD

This disclosure relates to wireless communication and, more specifically, to negotiation for coordinated medium access between wireless devices.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In WLANs, APs may reserve medium access periods (for example, transmission opportunities (TXOPs), target wake times (TWTs), or service periods) for transmissions within the TXOP of medium access period. During a restricted TWT (rTWTs), only the devices indicated as being allowed to transmit during that rTWT may be allowed to transmit. For example, an AP may indicate in a beacon which devices within the BSS are associated with each rTWT. In some WLANs, neighboring BSSs may be managed by a controller, which may control which BSS has access to the communication medium during each medium access period. In managed deployments, the central controller may prevent devices in a first BSS from transmitting in a medium access period belonging to or reserved for another BSS, and accordingly the neighboring BSSs may respect rTWTs in other BSSs. Some WLANs may not include a central controller for neighboring BSSs, however. In such unmanaged scenarios, APs may contend for medium access.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless device. The method may include transmitting, to a second wireless device, a request to negotiate a first set of medium access periods associated with the first wireless device, receiving, from the second wireless device, a response to the request to negotiate for the first set of medium access periods, and selectively communicating with a third wireless device during one or more medium access periods of the first set of medium access periods associated with the first wireless device in accordance with a negotiation with the response.

Another innovative aspect of the subject matter described in this disclosure can be implemented in first wireless device for wireless communications. The first wireless device may include a processing system that includes processor circuitry and memory circuitry that stores code. The processing system may be configured to cause the first wireless device to transmit, to a second wireless device, a request to negotiate a first set of medium access periods associated with the first wireless device, receive, from the second wireless device, a response to the request to negotiate for the first set of medium access periods, and selectively communicate with a third wireless device during one or more medium access periods of the first set of medium access periods associated with the first wireless device in accordance with a negotiation with the response.

Another innovative aspect of the subject matter described in this disclosure can be implemented in another first wireless device for wireless communications. The first wireless device may include means for transmitting, to a second wireless device, a request to negotiate a first set of medium access periods associated with the first wireless device, means for receiving, from the second wireless device, a response to the request to negotiate for the first set of medium access periods, and means for selectively communicating with a third wireless device during one or more medium access periods of the first set of medium access periods associated with the first wireless device in accordance with a negotiation with the response.

Another innovative aspect of the subject matter described in this disclosure can be implemented in a non-transitory computer-readable medium storing code for wireless communications. The code may include instructions executable by a processor to transmit, to a second wireless device, a request to negotiate a first set of medium access periods associated with the first wireless device, receive, from the second wireless device, a response to the request to negotiate for the first set of medium access periods, and selectively communicate with a third wireless device during one or more medium access periods of the first set of medium access periods associated with the first wireless device in accordance with a negotiation with the response.

Some examples of the method, first wireless devices, and non-transitory computer-readable medium described herein may further include operations, features, means, or instructions for receiving, from the second wireless device, a beacon indicating a second set of medium access periods associated with the second wireless device, where transmission of the request to negotiate may be responsive to the beacon.

In some examples of the method, first wireless devices, and non-transitory computer-readable medium described herein, receiving the response may include operations, features, means, or instructions for receiving an indication that the second wireless device will comply with one or more first medium access periods of the first set of medium access periods in exchange for compliance by the first wireless device with one or more second medium access periods associated with the second wireless device.

In some examples of the method, first wireless devices, and non-transitory computer-readable medium described herein, a first quantity of the one or more first medium access periods may be equal to a second quantity of the one or more second medium access periods.

In some examples of the method, first wireless devices, and non-transitory computer-readable medium described herein, a first quantity of the one or more first medium access periods may be within a threshold quantity of a second quantity of the one or more second medium access periods.

Some examples of the method, first wireless devices, and non-transitory computer-readable medium described herein may further include operations, features, means, or instructions for transmitting, to one or more client wireless devices of the first wireless device, an indication to refrain from transmission during the one or more second medium access periods.

In some examples of the method, first wireless devices, and non-transitory computer-readable medium described herein, receiving the response may include operations, features, means, or instructions for receiving an indication that the second wireless device will comply with one or more first medium access periods of the first set of medium access periods, where a quantity of the one or more first medium access periods may be based on a percentage of available medium access periods used by the first wireless device over a threshold duration.

In some examples of the method, first wireless devices, and non-transitory computer-readable medium described herein, receiving the response may include operations, features, means, or instructions for receiving an indication that the second wireless device will comply with each of the first set of medium access periods.

In some examples of the method, first wireless devices, and non-transitory computer-readable medium described herein, receiving the response may include operations, features, means, or instructions for receiving an indication that the second wireless device will not comply with the first set of medium access periods.

In some examples of the method, first wireless devices, and non-transitory computer-readable medium described herein, receiving the response may include operations, features, means, or instructions for receiving an indication that the second wireless device will comply with a subset of the first set of medium access periods.

One innovative aspect of the subject matter described in this disclosure can be implemented in method for wireless communications by a second wireless device. The method may include receiving, from a first wireless device, a request to negotiate a first set of medium access periods associated with the first wireless device, transmitting, to the first wireless device, a response to the request to negotiate for the first set of medium access periods, and communicating a beacon with a third wireless device in accordance with the response.

Another innovative aspect of the subject matter described in this disclosure can be implemented in a second wireless device for wireless communications. The second wireless device may include a processing system that includes processor circuitry and memory circuitry that stores code. The processing system may be configured to cause the second wireless device to receive, from a first wireless device, a request to negotiate a first set of medium access periods associated with the first wireless device, transmit, to the first wireless device, a response to the request to negotiate for the first set of medium access periods, and communicate a beacon with a third wireless device in accordance with the response.

Another innovative aspect of the subject matter described in this disclosure can be implemented in another second wireless device for wireless communications. The second wireless device may include means for receiving, from a first wireless device, a request to negotiate a first set of medium access periods associated with the first wireless device, means for transmitting, to the first wireless device, a response to the request to negotiate for the first set of medium access periods, and means for communicating a beacon with a third wireless device in accordance with the response.

Another innovative aspect of the subject matter described in this disclosure can be implemented in a non-transitory computer-readable medium storing code for wireless communications. The code may include instructions executable by a processor to receive, from a first wireless device, a request to negotiate a first set of medium access periods associated with the first wireless device, transmit, to the first wireless device, a response to the request to negotiate for the first set of medium access periods, and communicate a beacon with a third wireless device in accordance with the response.

Some examples of the method, second wireless devices, and non-transitory computer-readable medium described herein may further include operations, features, means, or instructions for transmitting a second beacon indicating a second set of medium access periods associated with the second wireless device, where the request to negotiate may be responsive to the beacon, and where the first set of medium access periods conflict with the second set of medium access periods and communicating with the third wireless device during one or more medium access periods of the second set of medium access periods associated with the second wireless device in accordance with the response.

In some examples of the method, second wireless devices, and non-transitory computer-readable medium described herein, transmitting the response may include operations, features, means, or instructions for transmitting an indication that the second wireless device will comply with one or more first medium access periods of the first set of medium access periods in exchange for compliance by the first wireless device with one or more second medium access periods associated with the second wireless device.

In some examples of the method, second wireless devices, and non-transitory computer-readable medium described herein, a first quantity of the one or more first medium access periods may be equal to a second quantity of the one or more second medium access periods.

In some examples of the method, second wireless devices, and non-transitory computer-readable medium described herein, a first quantity of the one or more first medium access periods may be within a threshold quantity of a second quantity of the one or more second medium access periods.

Some examples of the method, second wireless devices, and non-transitory computer-readable medium described herein may further include operations, features, means, or instructions for transmitting, to one or more client wireless devices of the second wireless device, an indication to refrain from transmission during the one or more first medium access periods.

In some examples of the method, second wireless devices, and non-transitory computer-readable medium described herein, transmitting the response may include operations, features, means, or instructions for transmitting an indication that the second wireless device will comply with one or more first medium access periods of the first set of medium access periods, where a quantity of the one or more first medium access periods may be based on a percentage of available medium access periods used by the first wireless device over a threshold duration.

In some examples of the method, second wireless devices, and non-transitory computer-readable medium described herein, transmitting the response may include operations, features, means, or instructions for transmitting an indication that the first wireless device will comply with each of the first set of medium access periods.

In some examples of the method, second wireless devices, and non-transitory computer-readable medium described herein, transmitting the response may include operations, features, means, or instructions for transmitting an indication that the second wireless device will not comply with the first set of medium access periods.

In some examples of the method, second wireless devices, and non-transitory computer-readable medium described herein, transmitting the response may include operations, features, means, or instructions for transmitting an indication that the second wireless device will comply with a subset of the first set of medium access periods.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication

network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a signaling diagram that supports negotiation for coordinated medium access between wireless devices.

FIG. 6 shows an example of a process flow that supports negotiation for coordinated medium access between wireless devices.

FIG. 7 shows a block diagram of an example wireless communication device that supports negotiation for coordinated medium access between wireless devices.

FIG. 8 shows a flowchart illustrating an example process performable by or at a first wireless device that supports negotiation for coordinated medium access between wireless devices.

FIG. 9 shows a flowchart illustrating an example process performable by or at a second wireless device that supports negotiation for coordinated medium access between wireless devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented by or in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to techniques for negotiation between wireless devices for medium access. Some aspects more specifically relate to requests and responses to negotiate for conflicting medium access periods between wireless devices, where the wireless devices may be in different basic service sets (BSSs). For example, wireless devices such as wireless access points (APs) may broadcast a reservation of medium access periods (for example, transmission opportunities (TXOPs), target wake times (TWTs), or service periods). A medium access period may also be referred to as timing information associated with communication periods. In some examples, a first wireless device may transmit a request to negotiate medium access periods with a second wireless device, and the second wireless device may transmit a response to the request. For example, the request to negotiate may request that the wireless devices mutually honor or respect (for example, comply with) one or more of the medium access period reservations of each wireless device. For example, based on a beacon from the second wireless device, the first wireless device may identify conflicts between the medium access periods reserved by the first and second wireless devices.

The first wireless device may request that the second wireless device comply with one or more of the medium access periods reserved by the first wireless device in exchange for compliance by the first wireless device with one or more of the medium access periods reserved by the second wireless device. For example, the first wireless device may refrain from transmitting during the medium access periods negotiated for the second wireless device, and the second wireless device may refrain from transmitting during the medium access periods negotiated for the first wireless device. In some examples, where the first and second wireless devices are wireless APs, the wireless APs may instruct the STAs within the corresponding BSS to also comply with the negotiated medium access periods (for example, to refrain from transmitting during the medium access periods belonging to the other BSS).

Particular aspects of the subject matter described in this disclosure can be implemented to realize one or more of the following potential advantages. In some examples, by mutually negotiating medium access periods, the described techniques can be used to reduce interference between neighboring wireless devices and particularly between neighboring BSSs in unmanaged scenarios (for example, in scenarios without a central controller managing the neighboring BSSs). In some examples, aspects of the subject matter described in this disclosure can be implemented to realize equitable division of medium access resources between wireless devices. Absent negotiations, each AP may attempt to reserve as many medium access periods as possible, even when the AP is not busy or does not have traffic to communicate, which may lead to high interference and high latency. Negotiation of medium access between neighboring wireless devices (for example, neighboring APs) may allow for each AP to have similar medium access usage, and may allow for the APs to account for an amount of traffic and/or priority of traffic. Such reservations of medium access periods (e.g., time domain reservations) may be used to support Quality of service (QOS) of certain applications that generate the user traffic (for example., extended reality (XR) or any type of periodic traffic that requires QoS or in general low latency). By implementing negotiations between neighboring devices, the QoS of served STAs may be achieved (e.g., by decreasing interference).

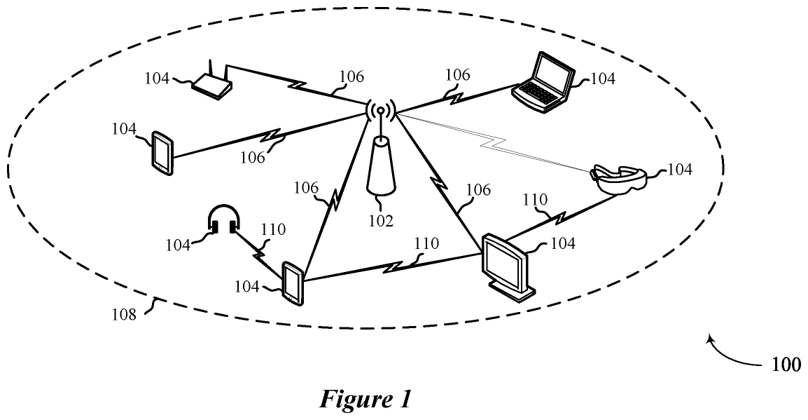

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless AP 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or XR wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via the direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 (e.g., WLAN) may transmit PPDUs over an unlicensed spectrum, which may be a portion of spectrum that includes frequency bands traditionally used by Wi-Fi technology, such as the 2.4 GHz, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHZ), FR3 (7.125 GHz-24.25 GHz), FR4a or FR4-1 (52.6 GHz-71 GHz), FR4 (52.6 GHz-114.25 GHZ), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

Puncturing is a wireless communication technique that enables a wireless communication device (such as an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as AP 102 or STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

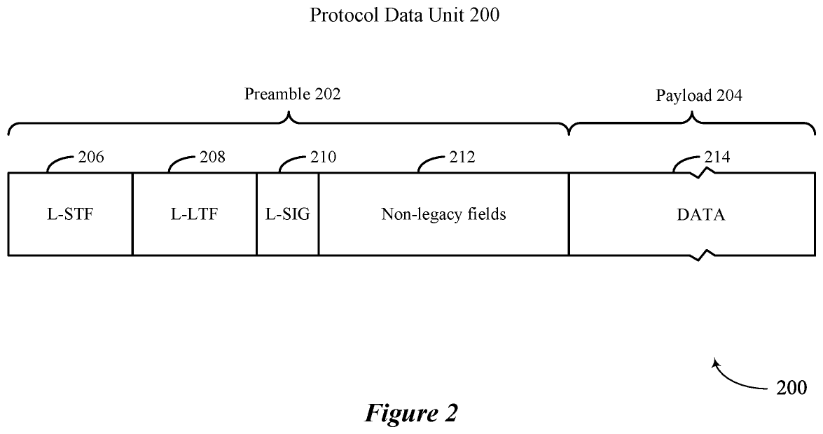

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a preamble 202 (e.g., PHY preamble) and a payload 204 (e.g., PHY payload). For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 (e.g., PHY payload) may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

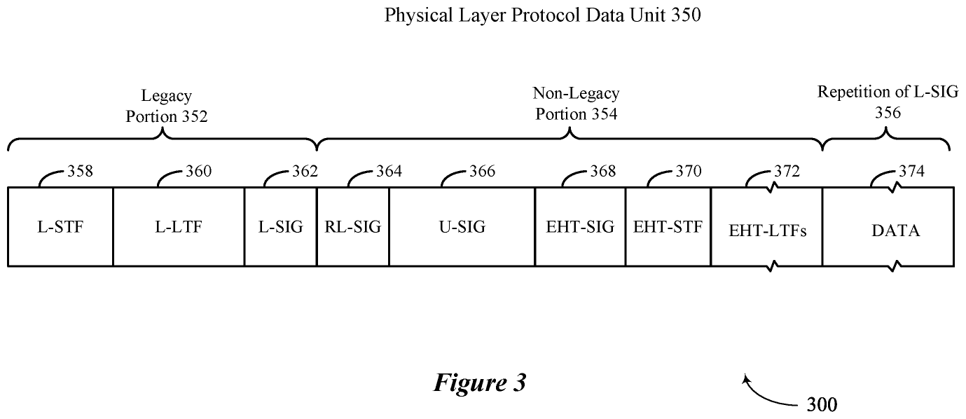

FIG. 3 shows an example of a diagram 300 describing a physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT-or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

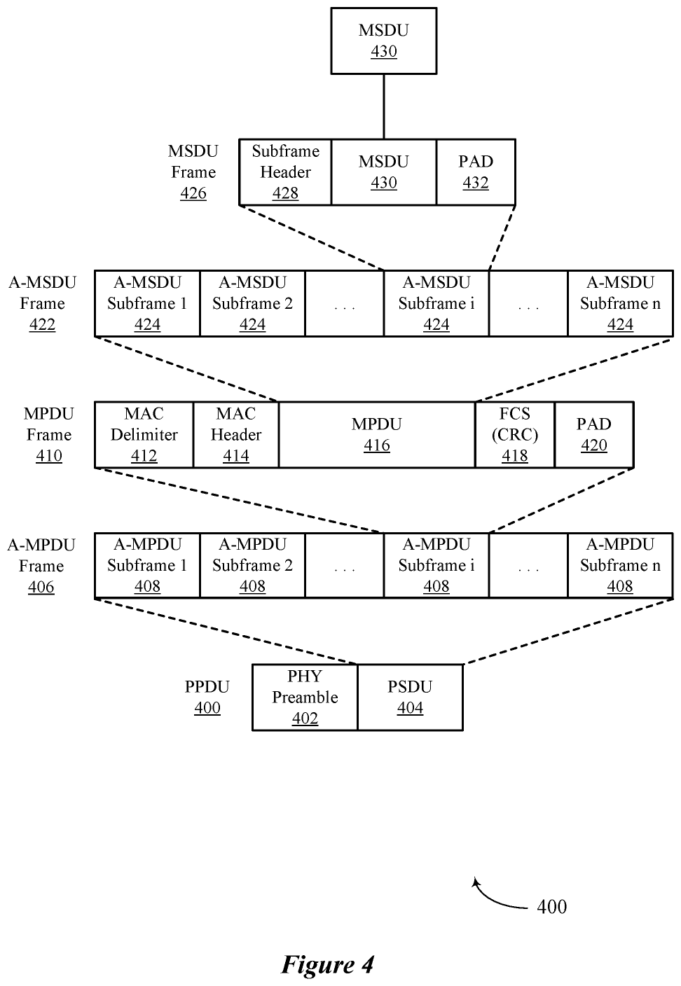

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) frame 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 (for example, MSDU frame 426) contains a corresponding MSDU 430 preceded by a subframe header 428 and in some cases followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address, or a destination address. The MAC header 414 may further include a frame control field containing control information. The frame control field may specify a frame type, for example, a data frame, a control frame, or a management frame.

Access to the shared wireless medium is generally governed by a distributed coordination function (DCF). With a DCF, there may generally be no centralized master device allocating time and frequency resources of the shared wireless medium. On the contrary, before a wireless communication device, such as an AP 102 or a STA 104, is permitted to transmit data, the wireless communication device may wait for a particular time and then contend for access to the wireless medium. The DCF may be implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The

CCA includes both physical (PHY-level) carrier sensing and virtual (MAC-level) carrier sensing.

Physical carrier sensing may be accomplished via a measurement of the received signal strength of a valid frame, which is then compared to a threshold to determine (for example, identify, detect, ascertain, calculate, or compute) whether the channel is busy. For example, if the received signal strength of a detected preamble is above a threshold, the medium is considered busy. Physical carrier sensing may also include energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of wireless communication network 100 (e.g., WLAN) in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

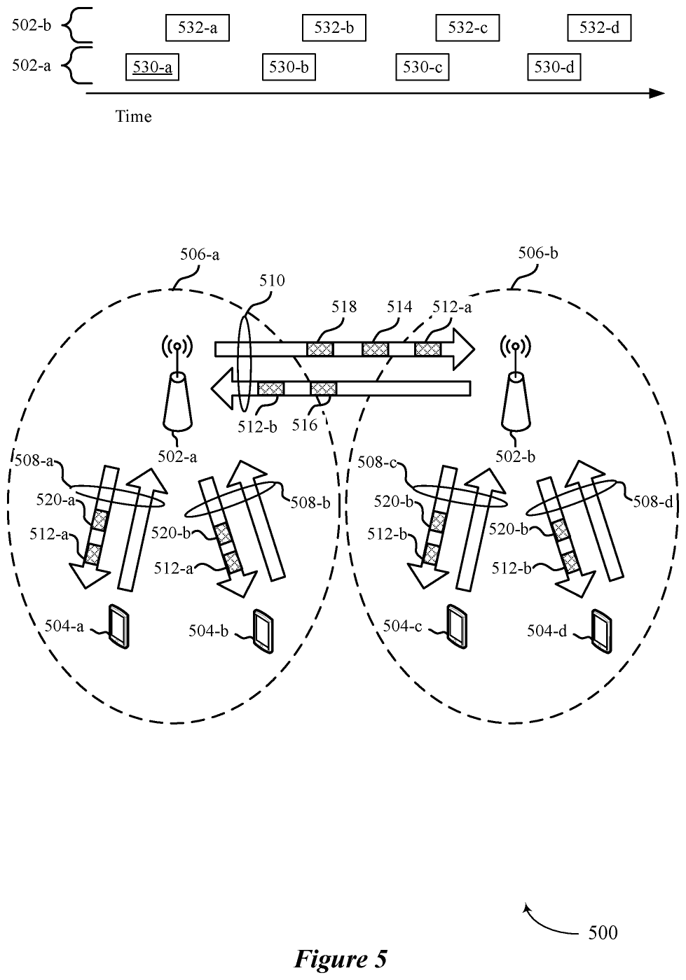

FIG. 5 shows an example of a signaling diagram 500 that supports negotiation for coordinated medium access between wireless devices. The signaling diagram 500 may implement or may be implemented by aspects of the wireless communication network 100. For example, the signaling diagram 500 includes a wireless device 502-a and a wireless device 502-b, which may be examples of APs 102 or an STAs 104 as described herein and with reference to FIG. 1. The signaling diagram 500 also may include a client wireless device 504-a, a client wireless device 504-b, a client wireless device 504-c, and a client wireless device 504-d, which may be examples of STAs 104 as described herein. The wireless device 502-a may communicate with the client wireless device 504-a via a communication link 508-a and the wireless device 502-a may communicate with the client wireless device 504-b via a communication link 508-b. The wireless device 502-b may communicate with the client wireless device 504-c via a communication link 508-c and the wireless device 502-b may communicate with the client wireless device 504-d via a communication link 508-d. For example, the wireless device 502-a may be an AP 102 or a softAP and the client wireless device 504-a and the client wireless device 504-b may be STAs 104, and the wireless device 502-a may serve a BSS 506-a. The communication link 508-a and the communication link 508-b may be examples of a communication link 106 described herein. Similarly, the wireless device 502-b may be an AP 102 or a softAP and the client wireless device 504-c and the client wireless device 504-d may be STAs 104, and the wireless device 502-b may serve a BSS 506-b. The communication link 508-c and the communication link 508-d may be examples of a communication link 106 described herein. The wireless device 502-a and the wireless device 502-b may communicate via a communication link 510, which may be an example of a communication link 106 described herein.

In some examples, the wireless device 502-a may transmit a beacon 512-a that indicates reserved medium access periods 530 (for example, as shown, a first medium access period 530-a, a second medium access period 530-b, a third medium access period 530-c, and a fourth medium access period 530-d) for the wireless device 502-a. The wireless device 502-b may transmit a beacon 512-b that indicates reserved medium access periods 532 (for example, as shown, a first medium access period 532-a, a second medium access period 532-b, a third medium access period 532-c, and a fourth medium access period 532-d) for the wireless device 502-b. One or more of the medium access periods 530 may conflict (for example, in time) with the medium access periods 532.

In some examples, the medium access periods may be restricted TWTs (rTWTs). During a restricted TWT (rTWTs), within a BSS 506, only the devices indicated as being allowed to transmit during that rTWT may be allowed to transmit. For example, the beacon 512-a may indicate that the client wireless device 504-a is allowed to transmit in the first medium access period 530-a, that the client wireless device 504-b is allowed to transmit in the second medium access period 530-b, and that the wireless device 502-a is allowed to transmit in the third medium access period 530-c and the fourth medium access period 530-d. Accordingly, rTWTs “reserve” airtime as rTWTs consume resources that could otherwise be shared. In some examples, as shown, if the medium access periods 530 conflict (for example, in time) with the medium access periods 532, devices in the BSS 506-b may transmit during the medium access periods 532, which may cause interference during the medium access periods 530 at the devices in the BSS 506-a. Absent incentives or rules, however, the wireless device 502-a and the wireless device 502-b may not negotiate or collaborate to determine which wireless device is allowed to transmit in each medium access period 530 and 532, which may result in interference during the medium access periods 530 and 532. As described herein, the wireless device 502-a and the wireless device 502-b may negotiate or collaborate to mutually honor or comply with each other's reserved medium access periods. Such collaboration schemes may involve fairness or equity between the wireless devices 502 (for example, no one wireless device 502 or BSS 506 deserves more airtime than another wireless device 502 or BSS 506). Although shown as two wireless devices 502 and two BSSs 506, any number of neighboring wireless devices 502 involving any number of neighboring BSSs 506 may collaborate as described herein. Such negotiations may apply between direct hop wireless devices (e.g., direct hop APs 102) and may not be applied to APs 102 that are more than 1 hop away from each other (for example, not in each other's range) as such APs 102 are unlikely to cause interference with each other.

For example, the wireless device 502-a may transmit a request 514 to the wireless device 502-b to negotiate the medium access periods 530 and the medium access periods 532. For example, the request 514 may request that the wireless device 502-b comply with one or more of the medium access periods 530. The wireless device 502-b may transmit a response 516 to the request 514 (e.g., which may indicate an acceptance in whole or in part or a rejection of the request to negotiate). The response 516 may indicate that the wireless device 502-b will comply with all of the requested medium access periods 530, with none of the requested medium access periods, or with some of the requested medium access periods 530.

In some examples, such as where the response 516 indicates that the wireless device 502-b will comply with all of the requested medium access periods 530 or with none of the requested medium access periods, the negotiation may be a 2-way handshake involving the request 514 and the response 516. In some examples, the response 516 may include a counter-offer. For example, a counter-offer may include that the wireless device 502-b will comply with some of the requested medium access periods 530 or that the wireless device 502-b will comply with some of the requested medium access periods 530 in exchange for the wireless device 502-a complying with some of the medium access periods 532.

In such examples where the response includes a counter-offer, the negotiation may involve a 3-way handshake including the request 514, the response 516, and a confirmation 518 transmitted by the wireless device 502-a to the response 516. For example, the request 514 may request the wireless device 502-b to comply with 5 medium access periods 530, and the response 516 may indicate that the wireless device 502-b is able to honor 2 of the 5 requested medium access periods 530 since the wireless device 502-b has 2 medium access periods 532 to exchange and that the wireless device 502-b will best-effort comply with the other 3 requested medium access periods.

In some examples, the request 514, the response 516, and the confirmation 518 may be transmitted via initial access signaling between APs. In some examples, the request may include identifiers for the requested medium access periods 530 (for example, based on the identifiers in the beacon 512-a). In some examples, to reject all of the requested medium access periods 530, the response 516 may include one or more bits set to “0”. In some examples, to accept all of the requested medium access periods 530, the response 516 may include one or more bits set to “1”. In some examples, the response 516 may include the identifiers for the requested medium access periods 530 and one or more bits indicating whether the wireless device 502-b accepts (for example, will comply with) or rejects (for example, will not comply with or will best effort comply with) each of the requested medium access periods 530. For example, the response 516 may include 1 bit saying accept/reject all or a set of bits that contains the identifiers of the medium access periods 530 that are accepted.

In some examples, the collaboration scheme may implement a 1:1 trade of medium access periods. For example, if the wireless device 502-a requests that the wireless device 502-b comply with a medium access period 530, the wireless device 502-a should comply with a medium access period 532 in return. The request 514 and/or the response 516 may indicate the identifiers of the exchanged medium access period 530 and medium access period 532. In some examples, the wireless device 502-b may not have a medium access period 532 to exchange. For example, the wireless device 502-a may not have a medium access period 532 to comply with in exchange for compliance by the wireless device 502-b with the requested medium access period 530.

Accordingly, in some examples, the collaboration scheme may implement a credit/debit count. For example, the collaboration scheme may allow or require one wireless device 502 (for example, the requestee wireless device) to honor or comply with a requested medium access period as long as there is a balance within some margin (for example, +/−3 medium access periods). In some examples, the collaboration scheme may allow the requestee wireless device to accept requests even when the credit/debit count is not satisfied, for example, if the requestee wireless device does not have much traffic to serve. As described herein, in some examples, the requestee wireless device (for example, the wireless device 502-b) may indicate in the response 516 that the wireless device 502-b will comply with a subset of the requested medium access periods. In some examples, the response 516 may indicate which requested medium access periods the wireless device 502-b will comply with, which requested medium access periods the wireless device 502-b will not comply with, and/or which requested medium access periods the wireless device 502-b will best-effort comply with (for example, will comply with if there is no or low traffic to serve).

In some examples, the negotiation may flexibly protect individual schedules instead of all schedules (for example, to protect medium access periods that are individual rTWTs and not broadcast rTWTs). In some examples, the credit/debit threshold may be adjusted, for example, based on the traffic load of the requestee or requestor wireless device. For example, the wireless device 502-b may lower the credit/debit threshold if the wireless device 502-b has more traffic to serve. Whether and/or which requested medium access periods 530 to accept also may depend on the channel bandwidth. In some examples, the response 516 may offer to share a portion of the medium access period 532 (for example, a rTWT airtime of the wireless device 502-b) with the wireless device 502-a.

In some examples, each wireless device 502 may track the approximate airtime usage of the medium access periods for each wireless device 502 and/or BSS 506 (for example, rTWT airtime usage). For example, each wireless device 502 may convert the medium access periods into airtime percentage (for example, maximum_TXOP/service_period=% of airtime reserved). In some examples, each wireless device 502 in a given BSS 506 may expect a total dedicated airtime for that wireless device to be less than or equal to 1/(the number of BSSs) to be honored or complied with by other wireless devices 502 in another BSS 506.

In some examples, the wireless device 502-b may indicate in a control message 520-b (for example, a beacon) to the client wireless devices 504 (for example, the client wireless device 504-c and the client wireless device 504-d) served by the wireless device 502-b the medium access periods 530 which the wireless device 502-b agreed to comply with. Accordingly, the client wireless devices 504 served by the wireless device 502-b may not transmit in the agreed upon medium access periods 530 and may not cause interference at the wireless device 502-a or to other client wireless devices 504 in the BSS 506-a. Similarly, the wireless device 502-a may indicate in a control message 520-a (for example, a beacon) to the client wireless devices 504 (for example, the client wireless device 504-a and the client wireless device 504-b) served by the wireless device 502-a the medium access periods 532 with which the wireless device 502-a has agreed to comply. Accordingly, the client wireless devices 504 served by the wireless device 502-a may not transmit in the agreed upon medium access periods 530 and may not cause interference at the wireless device 502-b or to other client wireless devices 504 in the BSS 506-b.

In some examples, the wireless devices 502 may transmit control signaling to the client wireless devices 504 served by the wireless devices when conditions change. For example, when more rTWT sessions are created, the wireless device 502 may inform the wireless devices 502 that the QoS of the current rTWT sessions may not be met). As another example, the wireless device 502 may deny or accept newly created rTWT sessions and may indicate an update to current rTWT sessions to the client wireless devices 504 based on the newly created rTWT sessions.

In some examples, the beacon 512-b or another signal from the wireless device 502-b may indicate that the wireless device 502-b is capable of coordinating medium access periods, and the wireless device 502-a may transmit the request 514 in response to the capability indication from the wireless device 502-b. In some examples, the beacon 512-b may indicate whether the medium access periods 532 are for the wireless device 502-b or for another BSS 506 (for example, other than the BSS 506-b) and/or the beacon 512-a may indicate whether the medium access periods 530 are for the wireless device 502-a or for another BSS 506 (for example, other than the BSS 506-a).

In some examples, as the wireless device 502-a and the wireless device 502-b are un-related (for example, not managed by a central controller), the medium access collaboration scheme may involve a security structure or security check. For example, security certificates may be used and applied to the wireless device 502-a and the wireless device 502-b (for example, where the wireless device 502-a and the wireless device 502-b are APs 102) for authentication. For example, a trusted third party authenticator (such as, Verisign) may hold a security certificate for the wireless device 502-a. The wireless device 502-a may indicate the security certificate in the request 514, and the wireless device 502-b may check the security certificate with the third party authenticator prior to and as a condition of transmitting the response 516. In some examples, the wireless device 502-a and the wireless device may apply frame count for replay protection of the security certificate (for example, in the request 514). In some examples, the wireless device 502-a may include a timestamp in with the security certificate to indicate the “freshness” of the security certificate. In some examples, if the wireless device 502-b does not have a copy of the trusted third party authenticator, the wireless device 502-b may maintain the certificate provided by the wireless device 502-a until expiration, and the wireless device 502-b may use the trusted third part certificate to validate or verify a certificate provided by a different wireless device 502. In some examples, the wireless device 502-a may include a vendor specific information element (IE) in the request that may authenticate the wireless device 502-a to the wireless device 502-b.

Similar authentication techniques may be included by the wireless device in the response 516 which the wireless device 502-a may use to authenticate the wireless device 502-b. In some examples, the request 514 may not include an authentication certificate, vendor specific IE, or any authentication procedure as the wireless device 502-b has freedom to reject or not respond to the request 514 (for example, subject to fairness rules as described herein).

In some examples, the wireless device 502-b may monitor the behavior of the wireless device 502-a to check if the wireless device 502-a or client wireless devices 504 in the BSS 506-a are using the medium access periods 530 agreed to by the wireless device 502-b. In some examples, if the wireless device 502-b determines that the wireless device 502-a or client wireless devices 504 in the BSS 506-a are not using the agreed upon medium access periods 530, the wireless device 502-b may determine that the wireless device 502-a is a rogue device and/or may stop complying with the agreed upon medium access periods 530. For example, the wireless device 502-b may transmit signaling to the wireless device 502-a indicating the wireless device 502-b will not comply with a remainder of the agreed upon medium access periods 530. The wireless device 502-a may similarly monitor the behavior of the wireless device 502-a with respect to the agreed upon medium access periods 532. In some examples, the wireless device 502-a may use automatic frequency coordination (AFC) to validate the wireless device 502-b (for example, the third party is the AFC) or the wireless device 502-b may use AFC to validate the wireless device 502-a.

In some examples, the negotiation scheme described herein may be applied to parameters other than medium access periods. For example, the wireless device 502-a and the wireless device 502-b may similarly transmit requests and responses to negotiate code and time division multiple access (c-TDMA) or coordinated spatial reuse. Different elements or fields within the request 514 and/or the response 516 (for example, frames used to transmit the request 514 and/or the response 516) may signal information, parameters, or capabilities related to different coordination schemes. In some examples, a request/response or notify/confirm framework may be defined which may include frames, elements, fields, reason codes, or status codes that may be used by one or more multi-BSS coordination schemes (e.g., including coordinated rTWT or medium access schemes). For example, such inter-BSS request/response or notify/confirm frameworks also may be used to negotiate c-TDMA, coordinated spatial reuse, or bandwidth between unrelated BSSs.

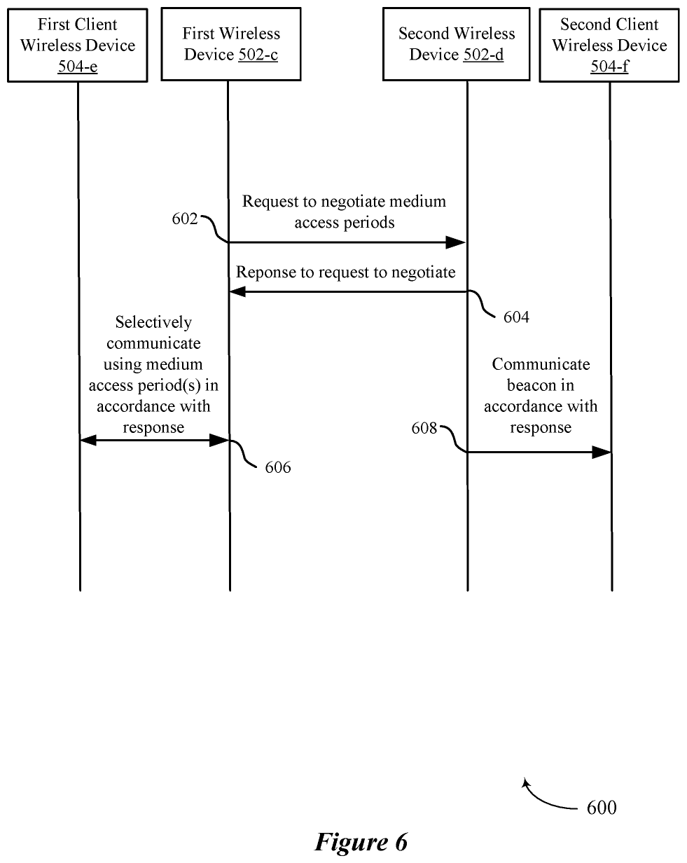

FIG. 6 shows an example of a process flow 600 that supports negotiation for coordinated medium access between wireless devices. The process flow 600 includes a first wireless device 502-c and a second wireless device 502-d, which may be examples of wireless devices 502 as described herein. For example, the first wireless device 502-c may be an AP 102 or an STA 104 as described herein, and the second wireless device 502-d may be an AP 102 or an STA 104 as described herein. The process flow also includes a first client wireless device 504-e and a second client wireless device 504-f, which may be examples of client wireless devices 504 as described herein. For example, the first client wireless device 504-e and the second client wireless device 504-f may be STAs 104 as described herein.

In the following description of the process flow 600, the operations between the first wireless device 502-c, the second wireless device 502-d, the first client wireless device 504-e, and the second client wireless device 504-f may be transmitted in a different order than the example order shown, or the operations performed by the first wireless device 502-c, the second wireless device 502-d, the first client wireless device 504-e, and the second client wireless device 504-f may be performed in different orders or at different times. Some operations also may be omitted from the process flow 600, and other operations may be added to the process flow 600.

At 602, the first wireless device 502-c may transmit, to the second wireless device 502-d, a request to negotiate a first set of medium access periods (for example, medium access periods 530 of FIG. 5) associated with the first wireless device 502-c. In some examples, the first wireless device is associated with a first BSS and the second wireless device is associated with a second BSS. In some examples, the first client wireless device 504-e may be associated with the first BSS and the second client wireless device 504-f may be associated with the second BSS.

At 604, the second wireless device 502-d may transmit, to the first wireless device 502-c, a response to the request to negotiate for the first set of medium access periods.

At 606, the first wireless device 502-c may selectively communicate with the first client wireless device 504-e in one or more medium access periods of the first set of medium access periods associated with the first wireless device 502-c in accordance with the response at 604. As used herein, selectively performing an action (e.g., selectively communicating) based on one or more factors is to be understood as meaning that whether or not the action is performed is based on (e.g., depends on) the one or more factors. For example, the first wireless device 502-c may communicate in medium access periods of the first set of medium access periods in which the first wireless device 502-c did not agree to refrain from communication. As another example, the first wireless device 502-c may communicate in medium access periods of the first set of medium access periods in which the second wireless device 502-d agreed to comply (e.g., agreed to refrain from communication) and may not communicate in medium access periods of the first set of medium access periods in which the second wireless device 502-d did not agree to comply (for example, did not agree to refrain from communication).

At 608, the second wireless device 502-d may communicate (for example, may transmit) a beacon with the second client wireless device 504-f—in accordance with the response at 604. For example, the beacon at 608 may announce the one or more medium access periods which the second wireless device 502-d agreed to comply with, and accordingly the second client wireless device 504-f may refrain from transmitting in the indicated one or more medium access periods reserved for the first wireless device 502-c.

In some examples, the second wireless device 502-d may transmit, and the first wireless device 502-c may receive, a beacon indicating a second set of medium access periods (for example, medium access periods 532 of FIG. 5) associated with the second wireless device 502-d, and transmission of the request to negotiate may be responsive to the beacon. For example, transmission of the request may be based on an identification by the first wireless device 502-c of a conflict between the first set of medium access periods and the second set of medium access periods. The second wireless device 502-d may communicate with the second client wireless device 504-f during one or more medium access periods of the second set of medium access periods associated with the second wireless device in accordance with the response.

In some examples, the response at 604 includes an indication that the second wireless device 502-d will comply with one or more first medium access periods of the first set of medium access periods in exchange for compliance by the first wireless device 502-c with one or more second medium access periods associated with the second wireless device (for example, one or more of the medium access periods 532 of FIG. 5). In some examples, a first quantity of the one or more first medium access periods is equal to a second quantity of the one or more second medium access periods. In some examples, a first quantity of the one or more first medium access periods is within a threshold quantity of a second quantity of the one or more second medium access periods. In some examples, the threshold quantity is based at least in part on a traffic level associated with the second wireless device. In some examples, the first wireless device 502-c may transmit, to the second wireless device 502-d, a confirmation message for the response.

In some examples, the first wireless device 502-c may transmit, to one or more client wireless devices of (for example, STAs in the same BSS as) the first wireless device 502-c, an indication to refrain from transmission during the one or more second medium access periods. In some examples, the second wireless device 502-d may transmit, to one or more client wireless devices of (for example, STAs in the same BSS as) the second wireless device 502-d, an indication to refrain from transmission during the one or more first medium access periods.

In some examples, the first wireless device 502-c may identify non-usage by the second wireless device 502-d of at least one medium access period of the one or more second medium access periods, and in response may transmit a control message to the second wireless device 502-d indicating that the first wireless device 502-c will not comply with a remainder of the one or more second medium access periods based on the non-usage by the second wireless device 502-d of the at least one medium access period. In some examples, the second wireless device 502-d may identify non-usage by the first wireless device 502-c of at least one medium access period of the one or more first medium access periods, and in response may transmit a control message to the first wireless device 502-c indicating that the second wireless device 502-d will not comply with a remainder of the one or more first medium access periods based on the non-usage by the first wireless device 502-c of the at least one medium access period.

In some examples, the response at 604 may include an indication that the second wireless device 502-d will comply with one or more first medium access periods of the first set of medium access periods, where a quantity of the one or more first medium access periods is based on a percentage of available medium access periods used by the first wireless device 502-c over a threshold duration.

In some examples, the response at 604 may include an indication that the second wireless device will comply with each of the first set of medium access periods. In some examples, the response at 604 may include an indication that the second wireless device will not comply with the first set of medium access periods. In some examples, the response at 604 may include an indication that the second wireless device will comply with a subset of the first set of medium access periods. In some examples, the first wireless device 502-c may transmit, to the second wireless device 502-d, a confirmation message for the response.

In some examples, the request at 602 may include a security key or a vendor specific IE associated with the first wireless device. In such examples, transmission of the response at 604 may be based on authentication by the second wireless device 502-d of the first wireless device 502-c based on the security key or the vendor specific IE.

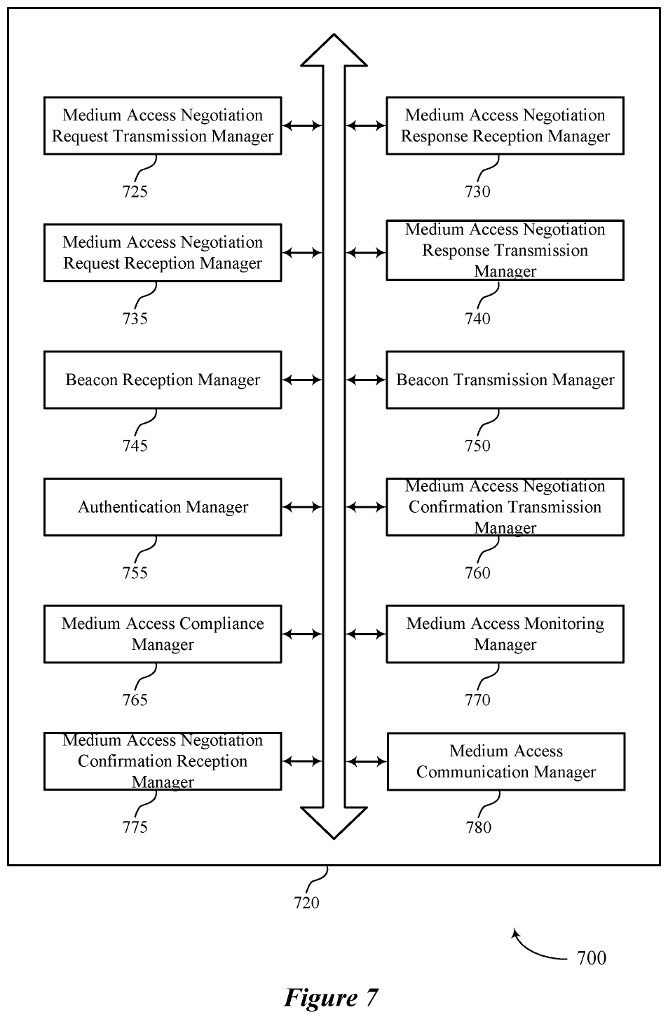

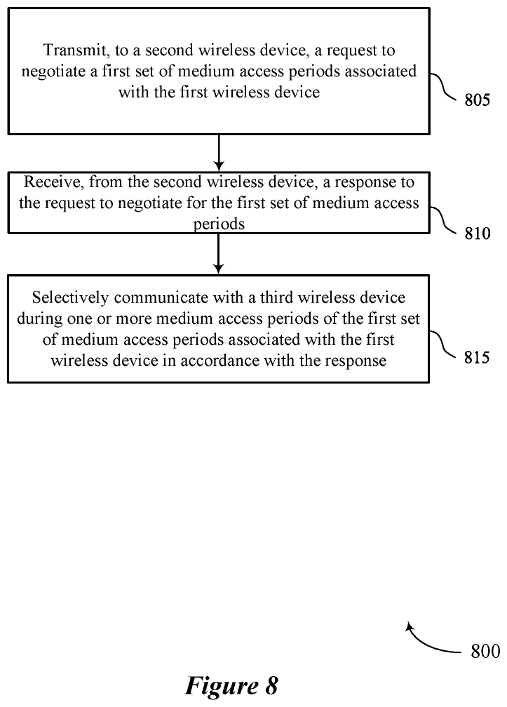

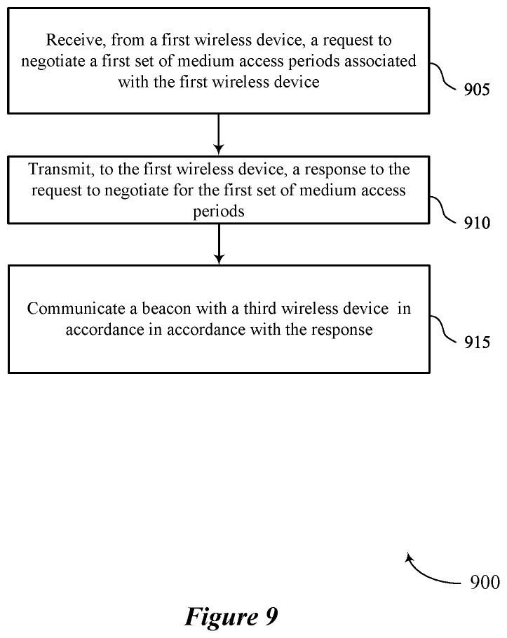

FIG. 7 shows a block diagram of an example wireless communication device 700 that supports negotiation for coordinated medium access between wireless devices. In some examples, the wireless communication device 700 is configured to perform the process 800 and the method 900 described with reference to FIGS. 8 and 9, respectively. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processsing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can configurable or configured for use in an AP or STA, such as the AP 102 or the STA 104 described with reference to FIG. 1. In some other examples, the wireless communication device 700 can be an AP or STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes a user interface (UI) (such as a touchscreen or keypad) and a display, which may be integrated with the UI to form a touchscreen display that is coupled with the processing system. In some examples, the wireless communication device 700 may further include one or more sensors such as, for example, one or more inertial sensors, accelerometers, temperature sensors, pressure sensors, or altitude sensors, that are coupled with the processing system. In some examples, the wireless communication device 700 further includes at least one external network interface coupled with the processing system that enables communication with a core network or backhaul network that enables the wireless communication device 700 to gain access to external networks including the Internet.

The communications manager 720 may support wireless communications at a wireless device in accordance with examples as disclosed herein. The wireless communication device 700 includes a medium access negotiation request transmission manager 725, a medium access negotiation response reception manager 730, a medium access negotiation request reception manager 735, a medium access negotiation response transmission manager 740, a beacon reception manager 745, a beacon transmission manager 750, an authentication manager 755, a medium access negotiation confirmation transmission manager 760, a medium access compliance manager 765, a medium access monitoring manager 770, a medium access negotiation confirmation reception manager 775, and a medium access communication manager 780. Portions of one or more of the medium access negotiation request transmission manager 725, the medium access negotiation response reception manager 730, the medium access negotiation request reception manager 735, the medium access negotiation response transmission manager 740, the beacon reception manager 745, the beacon transmission manager 750, the authentication manager 755, the medium access negotiation confirmation transmission manager 760, the medium access compliance manager 765, the medium access monitoring manager 770, the medium access negotiation confirmation reception manager 775, and the medium access communication manager 780 may be implemented at least in part in hardware or firmware. For example, one or more of the medium access negotiation request transmission manager 725, the medium access negotiation response reception manager 730, the medium access negotiation request reception manager 735, the medium access negotiation response transmission manager 740, the beacon reception manager 745, the beacon transmission manager 750, the authentication manager 755, the medium access negotiation confirmation transmission manager 760, the medium access compliance manager 765, the medium access monitoring manager 770, the medium access negotiation confirmation reception manager 775, and the medium access communication manager 780 may be implemented at least in part by at least a processor or a modem. In some examples, portions of one or more of the medium access negotiation request transmission manager 725, the medium access negotiation response reception manager 730, the medium access negotiation request reception manager 735, the medium access negotiation response transmission manager 740, the beacon reception manager 745, the beacon transmission manager 750, the authentication manager 755, the medium access negotiation confirmation transmission manager 760, the medium access compliance manager 765, the medium access monitoring manager 770, the medium access negotiation confirmation reception manager 775, and the medium access communication manager 780 may be implemented at least in part by a processor and software in the form of processor-executable code stored in memory.

The wireless communication device 700 may support wireless communications in accordance with examples as disclosed herein. The medium access negotiation request transmission manager 725 is configurable or configured to transmit, to a second wireless device, a request to negotiate a first set of medium access periods associated with the first wireless device. The medium access negotiation response reception manager 730 is configurable or configured to receive, from the second wireless device, a response to the request to negotiate for the first set of medium access period. The medium access communication manager 780 is configurable or configured to selectively communicate with a third wireless device during one or more medium access periods of the first set of medium access periods associated with the first wireless device in accordance with the response.

In some examples, the beacon reception manager 745 is configurable or configured to receive, from the second wireless device, a beacon indicating a second set of medium access periods associated with the second wireless device, where transmission of the request to negotiate is responsive to the beacon.

In some examples, to support receiving the response, the medium access negotiation response reception manager 730 is configurable or configured to receive an indication that the second wireless device will comply with one or more first medium access periods of the first set of medium access periods in exchange for compliance by the first wireless device with one or more second medium access periods associated with the second wireless device.

In some examples, a first quantity of the one or more first medium access periods be equal to a second quantity of the one or more second medium access periods.

In some examples, a first quantity of the one or more first medium access periods be within a threshold quantity of a second quantity of the one or more second medium access periods.

In some examples, the medium access negotiation confirmation transmission manager 760 is configurable or configured to transmit, to the second wireless device, a confirmation message for the response.

In some examples, the medium access compliance manager 765 is configurable or configured to transmit, to one or more client wireless devices of the first wireless device, an indication to refrain from transmission during the one or more second medium access periods.

In some examples, the medium access monitoring manager 770 is configurable or configured to identify non-usage by the second wireless device of at least one medium access period of the one or more second medium access periods. In some examples, the medium access monitoring manager 770 is configurable or configured to transmit a control message indicating that the first wireless device will not comply with a remainder of the one or more second medium access periods based on the non-usage by the second wireless device of the at least one medium access period.

In some examples, to support receiving the response, the medium access negotiation response reception manager 730 is configurable or configured to receive an indication that the second wireless device will comply with one or more first medium access periods of the first set of medium access periods, where a quantity of the one or more first medium access periods is based on a percentage of available medium access periods used by the first wireless device over a threshold duration.

In some examples, to support receiving the response, the medium access negotiation response reception manager 730 is configurable or configured to receive an indication that the second wireless device will comply with each of the first set of medium access periods.

In some examples, to support receiving the response, the medium access negotiation response reception manager 730 is configurable or configured to receive an indication that the second wireless device will not comply with the first set of medium access periods.

In some examples, to support receiving the response, the medium access negotiation response reception manager 730 is configurable or configured to receive an indication that the second wireless device will comply with a subset of the first set of medium access periods.

In some examples, the medium access negotiation confirmation transmission manager 760 is configurable or configured to transmit, to the second wireless device, a confirmation message for the response.

In some examples, the medium access negotiation request transmission manager 725 is configurable or configured to transmit, with the request, a security key or a vendor specific information element associated with the first wireless device.

In some examples, the first wireless device be associated with a first BSS and the second wireless device is associated with a second BSS.

Additionally, or alternatively, the wireless communication device 700 may support wireless communications in accordance with examples as disclosed herein. The medium access negotiation request reception manager 735 is configurable or configured to receive, from a first wireless device, a request to negotiate a first set of medium access periods associated with the first wireless device. The medium access negotiation response transmission manager 740 is configurable or configured to transmit, to the first wireless device, a response to the request to negotiate for the first set of medium access period. The medium access communication manager 780 is configurable or configured to communicate a beacon with a third wireless device in accordance with the response.

In some examples, the beacon transmission manager 750 is configurable or configured to transmit a second beacon indicating a second set of medium access periods associated with the second wireless device, where the request to negotiate is responsive to the beacon, and where the first set of medium access periods conflict with the second set of medium access periods. In some examples, the medium access communication manager 780 is configurable or configured to communicate with the third wireless device during one or more medium access periods of the second set of medium access periods associated with the second wireless device in accordance with the response.

In some examples, to support transmitting the response, the medium access negotiation response transmission manager 740 is configurable or configured to transmit an indication that the second wireless device will comply with one or more first medium access periods of the first set of medium access periods in exchange for compliance by the first wireless device with one or more second medium access periods associated with the second wireless device.

In some examples, a first quantity of the one or more first medium access periods be equal to a second quantity of the one or more second medium access periods.

In some examples, a first quantity of the one or more first medium access periods be within a threshold quantity of a second quantity of the one or more second medium access periods.

In some examples, the threshold quantity be based on a traffic level associated with the second wireless device.

In some examples, the medium access negotiation confirmation reception manager 775 is configurable or configured to receive, from the first wireless device, a confirmation message for the response.

In some examples, the medium access compliance manager 765 is configurable or configured to transmit, to one or more client wireless devices of the second wireless device, an indication to refrain from transmission during the one or more first medium access periods.

In some examples, the medium access monitoring manager 770 is configurable or configured to identify non-usage by the first wireless device of at least one medium access period of the one or more first medium access periods. In some examples, the medium access monitoring manager 770 is configurable or configured to transmit a control message indicating that the second wireless device will not comply with a remainder of the one or more first medium access periods based on the non-usage by the first wireless device of the at least one medium access period.

In some examples, to support transmitting the response, the medium access negotiation response transmission manager 740 is configurable or configured to transmit an indication that the second wireless device will comply with one or more first medium access periods of the first set of medium access periods, where a quantity of the one or more first medium access periods is based on a percentage of available medium access periods used by the first wireless device over a threshold duration.

In some examples, to support transmitting the response, the medium access negotiation response transmission manager 740 is configurable or configured to transmit an indication that the first wireless device will comply with each of the first set of medium access periods.

In some examples, to support transmitting the response, the medium access negotiation response transmission manager 740 is configurable or configured to transmit an indication that the second wireless device will not comply with the first set of medium access periods.

In some examples, to support transmitting the response, the medium access negotiation response transmission manager 740 is configurable or configured to transmit an indication that the second wireless device will comply with a subset of the first set of medium access periods.

In some examples, the medium access negotiation confirmation reception manager 775 is configurable or configured to receive, from the first wireless device, a confirmation message for the response.

In some examples, the authentication manager 755 is configurable or configured to receive, with the request, a security key or a vendor specific information element associated with the first wireless device, where transmission of the response is based on authentication of the security key or the vendor specific information element.

In some examples, the first wireless device be associated with a first BSS and the second wireless device is associated with a second BSS.

FIG. 8 shows a flowchart illustrating an example process 800 performable by or at a first wireless device that supports negotiation for coordinated medium access between wireless devices. The operations of the process 800 may be implemented by a first wireless device or its components as described herein. For example, the process 800 may be performed by a wireless communication device, such as the wireless communication device 700 described with reference to FIG. 7, operating as or within a wireless AP or a wireless STA. In some examples, the process 800 may be performed by a wireless AP or a wireless STA, such as one of the APs 102 or the STAs 104 described with reference to FIG. 1.

In some examples, in block 805, the first wireless device may transmit, to a second wireless device, a request to negotiate a first set of medium access periods associated with the first wireless device. The operations of block 805 may be performed in accordance with examples as disclosed herein. In some implementations, aspects of the operations of block 805 may be performed by a medium access negotiation request transmission manager 725 as described with reference to FIG. 7.

In some examples, in block 810, the first wireless device may receive, from the second wireless device, a response to the request to negotiate for the first set of medium access periods. The operations of block 810 may be performed in accordance with examples as disclosed herein. In some implementations, aspects of the operations of block 810 may be performed by a medium access negotiation response reception manager 730 as described with reference to FIG. 7.

In some examples, in block 815, the first wireless device may selectively communicate with a third wireless device during one or more medium access periods of the first set of medium access periods associated with the first wireless device in accordance with the response. The operations of block 815 may be performed in accordance with examples as disclosed herein. In some implementations, aspects of the operations of block 815 may be performed by a medium access communication manager 780 as described with reference to FIG. 7.

FIG. 9 shows a flowchart illustrating a method 900 that supports negotiation for coordinated medium access between wireless devices. The operations of the method 900 may be implemented by or its components as described herein. For example, the operations of the method 900 may be performed by. In some examples, may execute a set of instructions to control the functional elements of to perform the described functions. Additionally, or alternatively, may perform aspects of the described functions using special-purpose hardware.

At block 905, the method may include receiving, from a first wireless device, a request to negotiate a first set of medium access periods associated with the first wireless device. The operations of block 905 may be performed in accordance with examples as disclosed herein.

At block 910, the method may include transmitting, to the first wireless device, a response to the request to negotiate for the first set of medium access periods. The operations of block 910 may be performed in accordance with examples as disclosed herein.

At block 915, the method may include communicating a beacon with a third wireless device in accordance with the response. The operations of block 915 may be performed in accordance with examples as disclosed herein.

Implementation examples are described in the following numbered clauses:

Aspect 1: A method for wireless communications by a first wireless device, including: transmitting, to a second wireless device, a request to negotiate a first set of medium access periods associated with the first wireless device; receiving, from the second wireless device, a response to the request to negotiate for the first set of medium access periods; and selectively communicating with a third wireless device during one or more medium access periods of the first set of medium access periods associated with the first wireless device in accordance with a negotiation with the response.

Aspect 2: The method of aspect 1, further including: receiving, from the second wireless device, a beacon indicating a second set of medium access periods associated with the second wireless device, where transmission of the request to negotiate is responsive to the beacon.

Aspect 3: The method of any of aspects 1-2, where receiving the response includes: receiving an indication that the second wireless device will comply with one or more first medium access periods of the first set of medium access periods in exchange for compliance by the first wireless device with one or more second medium access periods associated with the second wireless device.

Aspect 4: The method of aspect 3, where a first quantity of the one or more first medium access periods is equal to a second quantity of the one or more second medium access periods.

Aspect 5: The method of any of aspects 3-4, where a first quantity of the one or more first medium access periods is within a threshold quantity of a second quantity of the one or more second medium access periods.

Aspect 6: The method of any of aspects 3-5, further including: transmitting, to the second wireless device, a confirmation message for the response.

Aspect 7: The method of any of aspects 3-6, further including: transmitting, to one or more client wireless devices of the first wireless device, an indication to refrain from transmission during the one or more second medium access periods.

Aspect 8: The method of any of aspects 3-7, further including: identifying non-usage by the second wireless device of at least one medium access period of the one or more second medium access periods; and transmitting a control message indicating that the first wireless device will not comply with a remainder of the one or more second medium access periods based on the non-usage by the second wireless device of the at least one medium access period.

Aspect 9: The method of any of aspects 1-8, where receiving the response includes: receiving an indication that the second wireless device will comply with one or more first medium access periods of the first set of medium access periods, where a quantity of the one or more first medium access periods is based at least in part on a percentage of available medium access periods used by the first wireless device over a threshold duration.

Aspect 10: The method of any of aspects 1-2, where receiving the response includes: receiving an indication that the second wireless device will comply with each of the first set of medium access periods.

Aspect 11: The method of any of aspects 1-2, where receiving the response includes: receiving an indication that the second wireless device will not comply with the first set of medium access periods.

Aspect 12: The method of any of aspects 1-2, where receiving the response includes: receiving an indication that the second wireless device will comply with a subset of the first set of medium access periods.

Aspect 13: The method of aspect 12, further including: transmitting, to the second wireless device, a confirmation message for the response.

Aspect 14: The method of any of aspects 1-13, further including: transmitting, with the request, a security key or a vendor specific information element associated with the first wireless device.

Aspect 15: The method of any of aspects 1-14, where the first wireless device is associated with a first BSS and the second wireless device is associated with a second BSS.

Aspect 16: A method for wireless communications by a second wireless device, including: receiving, from a first wireless device, a request to negotiate a first set of medium access periods associated with the first wireless device; transmitting, to the first wireless device, a response to the request to negotiate for the first set of medium access periods; and communicating a beacon with a third wireless device in accordance with the response.

Aspect 17: The method of aspect 16, further including: transmitting a second beacon indicating a second set of medium access periods associated with the second wireless device, where the request to negotiate is responsive to the beacon, and where the first set of medium access periods conflict with the second set of medium access periods; and communicating with the third wireless device during one or more medium access periods of the second set of medium access periods associated with the second wireless device in accordance with the response.

Aspect 18: The method of any of aspects 16-17, where transmitting the response includes: transmitting an indication that the second wireless device will comply with one or more first medium access periods of the first set of medium access periods in exchange for compliance by the first wireless device with one or more second medium access periods associated with the second wireless device.

Aspect 19: The method of aspect 18, where a first quantity of the one or more first medium access periods is equal to a second quantity of the one or more second medium access periods.

Aspect 20: The method of any of aspects 18-19, where a first quantity of the one or more first medium access periods is within a threshold quantity of a second quantity of the one or more second medium access periods.

Aspect 21: The method of aspect 20, where the threshold quantity is based on a traffic level associated with the second wireless device.

Aspect 22: The method of any of aspects 18-21, further including: receiving, from the first wireless device, a confirmation message for the response.

Aspect 23: The method of any of aspects 18-22, further including: transmitting, to one or more client wireless devices of the second wireless device, an indication to refrain from transmission during the one or more first medium access periods.

Aspect 24: The method of any of aspects 18-23, further including: identifying non-usage by the first wireless device of at least one medium access period of the one or more first medium access periods; and transmitting a control message indicating that the second wireless device will not comply with a remainder of the one or more first medium access periods based on the non-usage by the first wireless device of the at least one medium access period.

Aspect 25: The method of any of aspects 16-24 where transmitting the response includes: transmitting an indication that the second wireless device will comply with one or more first medium access periods of the first set of medium access periods, where a quantity of the one or more first medium access periods is based on a percentage of available medium access periods used by the first wireless device over a threshold duration.

Aspect 26: The method of any of aspects 16-17, where transmitting the response includes: transmitting an indication that the first wireless device will comply with each of the first set of medium access periods.

Aspect 27: The method of any of aspects 16-17, where transmitting the response includes: transmitting an indication that the second wireless device will not comply with the first set of medium access periods.

Aspect 28: The method of any of aspects 16-17, where transmitting the response includes: transmitting an indication that the second wireless device will comply with a subset of the first set of medium access periods.

Aspect 29: The method of aspect 28, further including: receiving, from the first wireless device, a confirmation message for the response.

Aspect 30: The method of any of aspects 16-29, further including: receiving, with the request, a security key or a vendor specific information element associated with the first wireless device, where transmission of the response is based on authentication of the security key or the vendor specific information element.

Aspect 31: The method of any of aspects 16-30, where the first wireless device is associated with a first BSS and the second wireless device is associated with a second BSS.

Aspect 32: A first wireless device for wireless communications, including one or more memories storing processor-executable code, and one or more processors coupled with the one or more memories and individually or collectively operable to execute the code to cause the first wireless device to perform a method of any of aspects 1-15.

Aspect 33: A first wireless device for wireless communications, including at least one means for performing a method of any of aspects 1-15.

Aspect 34: A non-transitory computer-readable medium storing code for wireless communications, the code including instructions executable by a processor to perform a method of any of aspects 1-15.

Aspect 35: A second wireless device for wireless communications, including one or more memories storing processor-executable code, and one or more processors coupled with the one or more memories and individually or collectively operable to execute the code to cause the second wireless device to perform a method of any of aspects 16-31.

Aspect 36: A second wireless device for wireless communications, including at least one means for performing a method of any of aspects 16-31.

Aspect 37: A non-transitory computer-readable medium storing code for wireless communications, the code including instructions executable by a processor to perform a method of any of aspects 16-31.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
transmit, to a second wireless device, a request to negotiate a first set of medium access periods associated with the first wireless device;
receive, from the second wireless device, a response to the request to negotiate for the first set of medium access periods; and
selectively communicate with a third wireless device during one or more medium access periods of the first set of medium access periods associated with the first wireless device in accordance with the response.

2. The first wireless device of claim 1, wherein the processing system is further configured to cause the first wireless device to:
receive, from the second wireless device, a beacon indicating a second set of medium access periods associated with the second wireless device, wherein transmission of the request to negotiate is responsive to the beacon.

3. The first wireless device of claim 1, wherein, to receive the response, the processing system is configured to cause the first wireless device to:
receive an indication that the second wireless device will comply with one or more first medium access periods of the first set of medium access periods in exchange for compliance by the first wireless device with one or more second medium access periods associated with the second wireless device.

4. The first wireless device of claim 3, wherein a first quantity of the one or more first medium access periods is equal to a second quantity of the one or more second medium access periods.

5. The first wireless device of claim 3, wherein a first quantity of the one or more first medium access periods is within a threshold quantity of a second quantity of the one or more second medium access periods.

6. The first wireless device of claim 3, wherein the processing system is further configured to cause the first wireless device to:
transmit, to the second wireless device, a confirmation message for the response.

7. The first wireless device of claim 3, wherein the processing system is further configured to cause the first wireless device to:
transmit, to one or more client wireless devices of the first wireless device, an indication to refrain from transmission during the one or more second medium access periods.

8. The first wireless device of claim 3, wherein the processing system is further configured to cause the first wireless device to:
identify non-usage by the second wireless device of at least one medium access period of the one or more second medium access periods; and
transmit a control message indicating that the first wireless device will not comply with a remainder of the one or more second medium access periods based at least in part on the non-usage by the second wireless device of the at least one medium access period.

9. The first wireless device of claim 1, wherein, to receive the response, the processing system is configured to cause the first wireless device to:
receive an indication that the second wireless device will comply with one or more first medium access periods of the first set of medium access periods, wherein a quantity of the one or more first medium access periods is based at least in part on a percentage of available medium access periods used by the first wireless device over a threshold duration.

10. The first wireless device of claim 1, wherein, to receive the response, the processing system is configured to cause the first wireless device to:
receive an indication that the second wireless device will comply with each of the first set of medium access periods.

11. The first wireless device of claim 1, wherein, to receive the response, the processing system is configured to cause the first wireless device to:
receive an indication that the second wireless device will not comply with the first set of medium access periods.

12. The first wireless device of claim 1, wherein, to receive the response, the processing system is configured to cause the first wireless device to:
receive an indication that the second wireless device will comply with a subset of the first set of medium access periods.

13. The first wireless device of claim 12, wherein the processing system is further configured to cause the first wireless device to:
transmit, to the second wireless device, a confirmation message for the response.

14. The first wireless device of claim 1, wherein the processing system is further configured to cause the first wireless device to:
transmit, with the request, a security key or a vendor specific information element associated with the first wireless device.

15. The first wireless device of claim 1, wherein the first wireless device is associated with a first basic service set and the second wireless device is associated with a second basic service set.

16. A second wireless device, comprising:
a processing system that includes processor circuitry and memory circuitry that stores code, the processing system configured to cause the second wireless device to:
receive, from a first wireless device, a request to negotiate a first set of medium access periods associated with the first wireless device;
transmit, to the first wireless device, a response to request to negotiate for the first set of medium access periods; and
communicate a beacon with a third wireless device in accordance with the response.

17. The second wireless device of claim 16, wherein the processing system is further configured to cause the second wireless device to:
transmit a second beacon indicating a second set of medium access periods associated with the second wireless device, wherein the request to negotiate is responsive to the beacon, and wherein the first set of medium access periods conflict with the second set of medium access periods; and
communicate with the third wireless device during one or more medium access periods of the second set of medium access periods associated with the second wireless device in accordance with the response.

18. The second wireless device of claim 16, wherein, to transmit the response, the processing system is configured to cause the second wireless device to:
transmit an indication that the second wireless device will comply with one or more first medium access periods of the first set of medium access periods in exchange for compliance by the first wireless device with one or more second medium access periods associated with the second wireless device.

19. The second wireless device of claim 18, wherein a first quantity of the one or more first medium access periods is equal to a second quantity of the one or more second medium access periods.

20. The second wireless device of claim 18, wherein a first quantity of the one or more first medium access periods is within a threshold quantity of a second quantity of the one or more second medium access periods.

21. The second wireless device of claim 20, wherein the threshold quantity is based at least in part on a traffic level associated with the second wireless device.

22. The second wireless device of claim 18, wherein the processing system is further configured to cause the second wireless device to:
receive, from the first wireless device, a confirmation message for the response.

23. The second wireless device of claim 18, wherein the processing system is further configured to cause the second wireless device to:
transmit, to one or more client wireless devices of the second wireless device, an indication to refrain from transmission during the one or more first medium access periods.

24. The second wireless device of claim 18, wherein the processing system is further configured to cause the second wireless device to:
identify non-usage by the first wireless device of at least one medium access period of the one or more first medium access periods; and
transmit a control message indicating that the second wireless device will not comply with a remainder of the one or more first medium access periods based at least in part on the non-usage by the first wireless device of the at least one medium access period.

25. The second wireless device of claim 16, wherein, to transmit the response, the processing system is configured to cause the second wireless device to:
transmit an indication that the second wireless device will comply with one or more first medium access periods of the first set of medium access periods, wherein a quantity of the one or more first medium access periods is based at least in part on a percentage of available medium access periods used by the first wireless device over a threshold duration.

26. The second wireless device of claim 16, wherein, to transmit the response, the processing system is configured to cause the second wireless device to:
transmit an indication that the first wireless device will comply with each of the first set of medium access periods.

27. The second wireless device of claim 16, wherein, to transmit the response, the processing system is configured to cause the second wireless device to:
transmit an indication that the second wireless device will not comply with the first set of medium access periods.

28. The second wireless device of claim 16, wherein, to transmit the response, the processing system is configured to cause the second wireless device to:
transmit an indication that the second wireless device will comply with a subset of the first set of medium access periods.

29. A method for wireless communications by a first wireless device, comprising:
transmitting, to a second wireless device, a request to negotiate a first set of medium access periods associated with the first wireless device;
receiving, from the second wireless device, a response to the request to negotiate for the first set of medium access periods; and
selectively communicating with a third wireless device during one or more medium access periods of the first set of medium access periods associated with the first wireless device in accordance with a negotiation with the response.

30. A method for wireless communications by a second wireless device, comprising:
receiving, from a first wireless device, a request to negotiate a first set of medium access periods associated with the first wireless device;
transmitting, to the first wireless device, a response to the request to negotiate for the first set of medium access periods; and
communicating a beacon with a third wireless device in accordance with the response.
